(19) United States
(12) Patent Application Publication
(10) Pub. No.: US 2008/0137796 A1
(43) Pub. Date: Jun. 12, 2008

(54) Method for reducing carbon steel corrosion in high temperature, high pressure water

(75) Inventor: Young-Jin Kim, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/295,352

(22) Filed: Dec. 6, 2005

(51) Int. Cl. G21C 9/00

(52) U.S. Cl. 376/305

(57) ABSTRACT

A method for reducing corrosion of carbon steel components, such as in a water-cooled nuclear reactor, having an oxide film layer formed on a surface thereof is provided. The method includes injecting a solution of a compound containing zinc into a supply of feedwater introduced into the nuclear reactor. The compound is decomposed under operating reactor thermal conditions to release atoms of zinc. The atoms of zinc are incorporated into the oxide film layer to increase a corrosion resistance of carbon steel.

### BACKGROUND OF THE INVENTION

This invention relates generally to nuclear reactors and more particularly, to a method for reducing the corrosion of carbon steel and low alloy steel components in nuclear reactors.

High temperature, high pressure water can be found in a variety of known apparatus, such as water deaerators, nuclear reactors and steam-driven central station power generation systems. For example, a nuclear reactor pressure vessel contains a reactor coolant, e.g., water, which removes heat from the nuclear reactor core. Piping systems and/or circuits carry the heated water or steam to the steam generators or turbines, and circulate feedwater back to the vessel. Operating pressures and temperatures for the reactor pressure vessel are about 7 megapascals (MPa) and 288° C. for a boiling water nuclear reactor (BWR), and about 15 MPa and 320° C. for a pressurized water nuclear reactor (PWR). The components and materials used in BWRs and PWRs must withstand various loading, environmental and radiation conditions.

Carbon steel components are used extensively in low pressure and high pressure turbine sections, and feedwater heaters and bottom drain lines in nuclear power plants including many ancillary components of the steam-water circuit, such as moisture separators and reheaters. In these components, high flow velocities under single-phase water or two-phase wet steam conditions prevail. Despite careful selection and treatment of these components, corrosion occurs when the components are exposed to the high temperature, high pressure reactor water. Such corrosion contributes to a host of problems including stress corrosion cracking, crevice corrosion, erosion corrosion, sticking of pressure relief valves and buildup of gamma radiation-emitting isotopes, such as a Co-60.

In nuclear reactors, the feedwater and bottom drain line piping system components are subjected to flow assisted corrosion. As used herein, references to the term “flow assisted corrosion” are to be understood to refer to an effect of fluid flow that accelerates general corrosion by increasing the rate of mass transport of reactive species to and from the metal surface, and acceleration or increase in the rate of corrosion caused by the relative movement between a corrosive fluid and the metal surface. Corrosion products in reactors cause problems relating to radiation level, radioactive waste and heat transfer. Thus, controlling corrosion within nuclear reactor components is important to maintain the nuclear reactor functioning safely and properly.

Damage associated with flow assisted corrosion of such power plant components generally occurs at locations where there is severe fluid turbulence adjacent to the metal surface, either from high fluid velocities or due to the presence of features such as bends or orifices that generate high local turbulence levels. A thin layer of oxide having a thickness of about one micron or less is normally present on the corroding surface, but the rate of penetration in these localized areas deprived of a characteristic double layer oxide film can reach values as high as 0.1 to 10 millimeters per year. Such rates of metal removal are unacceptable in power plants which have a design lifetime of 30 to 40 years, but even significantly lower rates of penetration may generate undesirable high concentrations of corrosion products in the water circuits.

It is known that oxygen can be added to low-oxygen, hydrazine or hydrogen water, e.g. the feedwater of nuclear reactors, to decrease flow assisted corrosion of carbon steel components. However, it is well documented that stress corrosion cracking of stainless steel, low alloy steel, and nickel based alloys occurs at higher rates when oxygen is present at concentrations of about 5 parts per billion or greater in the high temperature water of a nuclear reactor. Therefore, it is desirable to minimize oxygen concentration in reactor water to reduce stress corrosion cracking of stainless steel, low alloy, and nickel based alloy components.

Although no comprehensive model of flow assisted corrosion which can fully describe the effect of the variables mentioned above has yet been developed, it is believed that the corrosion rates observed at high flow velocities are due to enhanced dissolution of magnetite leading to accelerated metal loss as iron oxidizes to replace the dissolved film.

### BRIEF DESCRIPTION OF THE INVENTION

In one aspect, the present invention provides a method for reducing corrosion of carbon steel components and/or low alloy steel components in a nuclear reactor having an oxide film layer formed on a surface thereof. The method includes injecting a solution of a compound containing zinc into a supply of feedwater introduced into the nuclear reactor. The compound is decomposed under operating reactor thermal conditions to release ions of zinc and/or atoms of zinc. The ions of zinc and/or the atoms of zinc are introduced into the oxide film layer to increase a corrosion resistance of carbon steel when incorporated into the oxide film layer.

In another aspect, the present invention provides a method for improving an erosion corrosion resistance of a carbon steel component including a surface having an oxide film thereon. The method includes immersing the carbon steel surface in high temperature water in which a compound containing zinc is dissolved. The compound is decomposed in the high temperature water to release ions of zinc and/or atoms of zinc. The ions of zinc and/or the atoms of zinc are incorporated into the oxide film such that the ions of zinc and/or the atoms of zinc increase the erosion corrosion resistance of the carbon steel.

In another aspect, the present invention provides a method for reducing corrosion of a carbon steel component and/or a low alloy steel component for a nuclear reactor containing low oxygen feedwater. The method includes adding one of a zinc metal and a zinc oxide as an alloying element to the carbon steel component and/or the low alloy steel component in a concentration not greater than about 20 weight %.

### BRIEF DESCRIPTION OF THE DRAWINGS

FIG. 1 is a sectional view, with parts cut away, of a boiling water nuclear reactor pressure vessel, according to one embodiment of the present invention;

FIG. 2 is a graph of an elemental distribution of an oxide layer formed on a carbon steel specimen after the carbon steel specimen was immersed in water having a temperature of 180° C. containing 150 ppb H₂ for two weeks;

FIG. 3 is a graph of an elemental distribution of an oxide layer formed on a carbon steel specimen after the carbon steel specimen was immersed in water having a temperature of 180° C. containing 150 ppb H₂ and 20 ppb Zn for two weeks;

FIG. 4 is a graph of a x-ray spectroscope (XPS) elemental profile of an oxide layer formed on a carbon steel specimen after the carbon steel specimen was immersed in water having a temperature of 180° C. containing 150 ppb H₂ and 20 ppb Zn for two weeks; and

FIG. 5 is a graph of an average weight loss of carbon steel as a function of immersion time for carbon steel control group specimens immersed in water having a temperature of 180° C. containing 150 ppb H₂ and for carbon steel test group specimens immersed in water having a temperature of 180° C. containing 150 ppb H₂ and 20 ppb Zn.

### DETAILED DESCRIPTION OF THE INVENTION

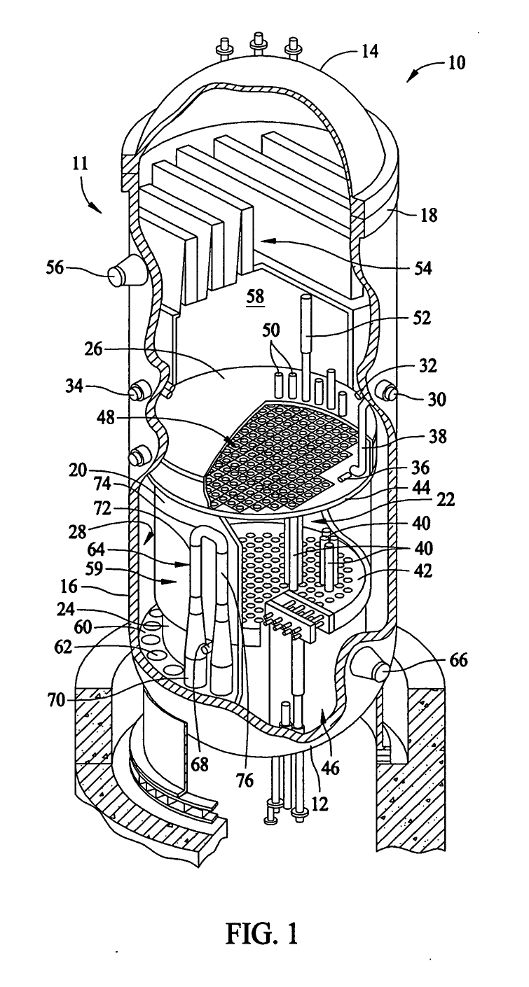

The present invention provides a method for reducing the corrosion of carbon steel and/or low alloy steel components in high temperature, high pressure water. The present invention is described below in reference to its application in connection with and operation of a boiling water nuclear reactor (BWR). However, it will be obvious to those skilled in the art and guided by the teachings herein provided that the present invention is not limited to its application in connection with a BWR. Rather, the present invention may be utilized in other structures in which structural components are exposed to high temperature, high pressure water environments. Such structures include, but are not limited to, pressurized water nuclear reactors (PWRs), such as Russian VVER reactors, pressurized heavy water reactors (PHWRs) such as the Canada Deuterium Uranium (CANDU) reactor, steam-driven turbines, water deaerators and the like. Thus, referring to the drawings in general and to FIG. 1 in particular, it will be understood that the illustrations are for purposes of describing embodiments of the invention and are not intended to be construed as limiting.

As used herein, references to “high temperature water” are to be understood to refer to water, steam and/or the condensate thereof, generally having a temperature between about 50° C. and about 350° C., and about 100° C. to about 330° C. in a particular embodiment.

Referring to FIG. 1, a boiling water nuclear reactor (BWR) 10 includes a boiling water nuclear reactor pressure vessel (RPV) 11. FIG. 1 is a sectional view, with portions cut away, of RPV 11. RPV 11 has a generally cylindrical shape and is closed at a bottom end by a bottom head 12 and at an opposing top end by a removable top head 14. A side wall 16 extends from bottom head 12 to top head 14. Side wall 16 includes a top flange 18. Top head 14 is attached to top flange 18. A cylindrically-shaped core shroud 20 surrounds a reactor core 22. Shroud 20 is supported at one end by a shroud support 24 and includes a removable shroud head 26 at the other end. An annulus 28 is formed between shroud 20 and side wall 16.

A fluid flow through BWR 10 is generally described with reference to FIG. 1. Feedwater is admitted into RPV 11 through a feedwater inlet 30 and a feedwater sparger 32. Feedwater sparger 32 includes a ring-shaped pipe having suitable apertures for circumferentially distributing the feedwater inside RPV 11. A core spray inlet 34 supplies water to a core spray sparger 36 through a core spray line 38. The feedwater from feedwater sparger 32 flows downwardly through annulus 28. Shroud 20 is typically a stainless steel cylinder which surrounds reactor core 22 including a plurality of fuel assemblies 40. Each fuel assembly 40 is aligned and supported by a core plate 42 located at a base of reactor core 22. A top guide 44 aligns each fuel assembly 40 as each fuel assembly 40 is lowered into reactor core 22. Core plate 42 and top guide 44 are supported by shroud 20. Water flows through annulus 28 into core lower plenum 46.

Heat is generated within reactor core 22, which includes fuel assemblies 40 of fissionable material. Water circulated up through reactor core 22 is at least partially converted to steam. In one embodiment, the water enters fuel assemblies 40 disposed within reactor core 22, wherein a boiling boundary layer (not shown) is established. A mixture of water and steam enters core upper plenum 48 under shroud head 26. Core upper plenum 48 provides standoff between the steam-water mixture exiting reactor core 22 and entering vertical standpipes 50, which are disposed atop shroud head 26 and in fluid communication with core upper plenum 48.

The steam-water mixture flows through standpipes 50 and enters steam separators 52. Steam separators 52 separate steam from water, which is recirculated. Residual water is removed from the steam by steam dryers 54. The steam exits RPV 11 through a steam outlet 56 near top head 14. The separated liquid water then mixes with the feedwater in mixing plenum 58, and the mixture then returns to reactor core 22 through annulus 28.

In one embodiment, BWR 10 also includes a coolant recirculation system 59 that provides a forced convection flow through the core necessary to attain the required power density. A pump deck 60, which has a ring shape, extends between shroud support 24 and side wall 16. Pump deck 60 includes a plurality of circular openings 62. Each opening 62 houses a jet pump assembly 64. Jet pump assemblies 64 are circumferentially distributed around shroud 20. A portion of the water is sucked from the lower end of annulus 28 via recirculation water outlet 66 and forced by a centrifugal recirculation pump (not shown) into jet pump assemblies 64 (only one of which is shown) through recirculation water inlets 68. BWR 10 has two recirculation pumps, each of which provides the driving flow for a plurality of jet pump assemblies 64. The pressurized driving water is supplied to each jet pump nozzle 70 through an inlet riser 72, an elbow 74 and an inlet mixer 76. In one embodiment, BWR 10 includes 16 to 24 inlet mixers 76.

Erosion-corrosion is frequently observed in regions of highly disturbed cooling water flow during the operation of BWR 10 under hydrogen water chemistry conditions, such as within the coolant recirculation system and/or the piping systems and conduits carrying heated water or steam, as well as the piping systems and conduits circulating the feedback water through RPV 11. Carbon steel is used extensively in components of BWR 10 and erosion-corrosion of carbon steel in water and wet steam is known to be a major failure problem.

In one embodiment, a method for reducing corrosion of carbon steel components in a water-cooled nuclear reactor and/or associated components having an oxide film layer formed on a surface thereof is provided. In this embodiment, the method includes injecting a solution of a compound containing zinc into the water of the water-cooled nuclear reactor, such as into a supply of feedwater introduced into the nuclear reactor. In a particular embodiment, the temperature of the feedwater is maintained at about 100° C. to about 330° C. Further, the feedwater is maintained in a reducing condition, e.g., low oxygen content, such as low-oxygen, hydrazine or hydrogen water chemistry having an oxygen concentration of less than about 15 ppb. The compound decomposes and/or dissolves under operating reactor thermal conditions to release ions and/or atoms of zinc which incorporate into the oxide film layer. Because the zinc additions become ionic (Zn⁺⁺ and/or ZnOH⁺) in high temperature water, the various forms of zinc ions and/or zinc atoms are incorporated into the oxide film layer.

Upon injection of a solution of a compound containing zinc into the feedwater, the compound undergoes decomposition and/or dissolves under operating reactor thermal conditions to release ions and/or atoms of zinc at a rate such that the concentration of zinc in the feedwater is sufficient, once incorporated into the oxide film layer, to enhance a corrosion resistance of the carbon steel component. Such corrosion includes, for example, a flow assisted corrosion and/or an erosion corrosion. Further, the incorporation of zinc into the oxide film layer increases a resistance of the oxide film layer to rupture, as well as increases a strain rate of the oxide film layer.

In one embodiment, the zinc-containing compound includes depleted ZnO, commercial ZnO, Zn compounds like ZnCl₂, Zn(NO₃)₂, Zn acetate, ZnBr₂, ZnSO₄, fumed Zn compounds, nanoparticles of pure Zn and/or nanoparticles of Zn compounds. The compound is injected into a supply of the feedwater in an amount sufficient to produce a zinc concentration of about 0.1 ppt to about 200 ppb, and about 50 ppb to about 150 ppb in a particular embodiment. In an alternative embodiment, the compound contains a plurality of zinc and/or zinc oxide nanoparticles that are injected into the feedwater. The zinc and/or zinc oxide nanoparticles have a mean diameter not greater than about 100 nanometers. In other alternative embodiments, at least a portion of the zinc and/or zinc oxide nanoparticles have a mean diameter greater than about 100 nanometers depending upon the solubility of the zinc-containing compound injected into the feedwater. The nanoparticles are distributed and/or redistributed on the oxide film layer in response to an interaction with electrostatic forces of the feedwater.

The zinc-containing compound or the zinc-containing nanoparticles can be introduced into the high temperature, high pressure water during various stages of operation of BWR 10. Further, the zinc-containing compound or the zinc-containing nanoparticles are provided to the high temperature, high pressure water during full power operation, cool down, outage, heat-up, hot standby and/or low power operation of BWR 10.

The zinc-containing compound or the zinc-containing nanoparticles are introduced into the high temperature, high pressure water at any location within BWR 10 where thorough mixing of the zinc-containing compound or the zinc-containing nanoparticles occurs. The locations at which the zinc-containing compound or the zinc-containing nanoparticles are introduced include, without limitation, a residual heat removal piping, coolant recirculation system 59, jet pump assemblies 64, feedwater lines such as at feedwater inlet 30 and/or feed water sparger 32, core delta P lines, control rod drive cooling water lines, water level control points and/or reactor water clean-up systems.

In one embodiment, the erosion corrosion resistance of a carbon steel surface having an oxide film thereon is increased by immersing the carbon steel surface in high temperature water in which a compound containing zinc is dissolved. The compound includes depleted ZnO, commercial ZnO, Zn compounds like ZnCl₂, Zn(NO₃)₂, Zn acetate, ZnBr₂, ZnSO₄, fumed Zn compounds, nanoparticles of pure Zn and/or nanoparticles of Zn compounds. As the compound decomposes and/or dissolves in the high temperature water, atoms of zinc are released from the compound, which incorporate into the oxide film. Zinc increases the erosion corrosion resistance of the carbon steel when incorporated into the oxide film. In this embodiment, the compound dissolved within the high temperature water produces a zinc concentration not greater than about 150 ppb, and about 100 ppb to about 150 ppb in a particular embodiment. In alternative embodiments, the dissolved compound produces a zinc concentration greater than about 150 ppb.

By introducing compounds and/or nanoparticles containing Zn or ZnO into high temperature water, the Zn-containing oxide, ZnFe₂O₄, enhances a strain rate of the carbon steel oxide and, thus, increases the resistance of the oxide film layer to rupture. The fine particulates or nanoparticles are responsive to electrostatic forces or zeta potentials in the high temperature water and can be distributed on the oxide film layer surface. Thus, the presence of Zn or ZnO materials on the oxide film layer surface can reduce the corrosion rate of carbon steel in high temperature water containing H₂.

In an alternative embodiment, a suitable coating of zinc metal or zinc oxides is at least sufficient to increase the corrosion resistance of the carbon steel. For example, a suitable coating can be formed by electroless plating for about 30 seconds or more, having a thickness of about 0.3 microns or greater. The zinc metal or zinc oxide coating can be deposited by methods well known in the art for depositing continuous or substantially continuous coatings on metal substrates, such as plasma spraying, flame spraying, chemical vapor deposition, physical vapor deposition processes such as sputtering, welding such as metal inert gas welding, electroless plating and electrolytic plating. It is apparent to those skilled in the art and guided by the teachings herein provided that in alternative embodiments, any suitable method is used to deposit the zinc metal or zinc oxide coating on the carbon steel components. In a particular embodiment, a zinc metal or zinc oxide is added as an alloying element to the carbon steel components and/or the low alloy steel components. The zinc metal or zinc oxide is added in a suitable concentration, e.g., up to about 20 weight %.

In one embodiment, a coating of zinc metal or zinc oxide on carbon steel components increases the corrosion resistance of the carbon steel component in high temperature, high pressure water. As a result, the thin oxide layers that are soluble in flowing high temperature, high pressure water and lead to unacceptable levels of flow assisted corrosion are not formed on the components. Rather, flow assisted corrosion is substantially reduced on the coated components when the water is provided with a compound containing a concentration of zinc of about 0.1 ppt to about 200 ppb, and in a particular embodiment about 50 ppb to about 150 ppb.

Additional features and advantages of the method of this invention are further shown by the following example.

### EXAMPLE 1

Several carbon steel test specimens having an ASTM designation UNS G10180 comprised of about 0.17 weight percent carbon and 0.8 weight percent manganese, were used to test the effectiveness of a zinc-containing compound in reducing the corrosion of carbon steel components within a high temperature water environment. A control group of five carbon steel test specimens were exposed to high temperature water containing 150 ppb hydrogen (H₂) without the addition of zinc. Additionally, a test group of five carbon steel test specimens were exposed to high temperature water containing 150 ppb H₂ and including zinc (Zn). The zinc was introduced into the high temperature water in the form of Zn(NO₃)₂.

Each of the carbon steel control specimens and each of the carbon steel test specimens were immersed in water having a temperature of 180° C. for a testing time period of two weeks. The control test group specimens were immersed in high temperature water containing 150 ppb H₂. The test group specimens were immersed in high temperature water containing 150 ppb H₂ with Zn(NO₃)₂ introduced into the high temperature water to provide a zinc concentration within the high temperature water of 20 ppb Zn.

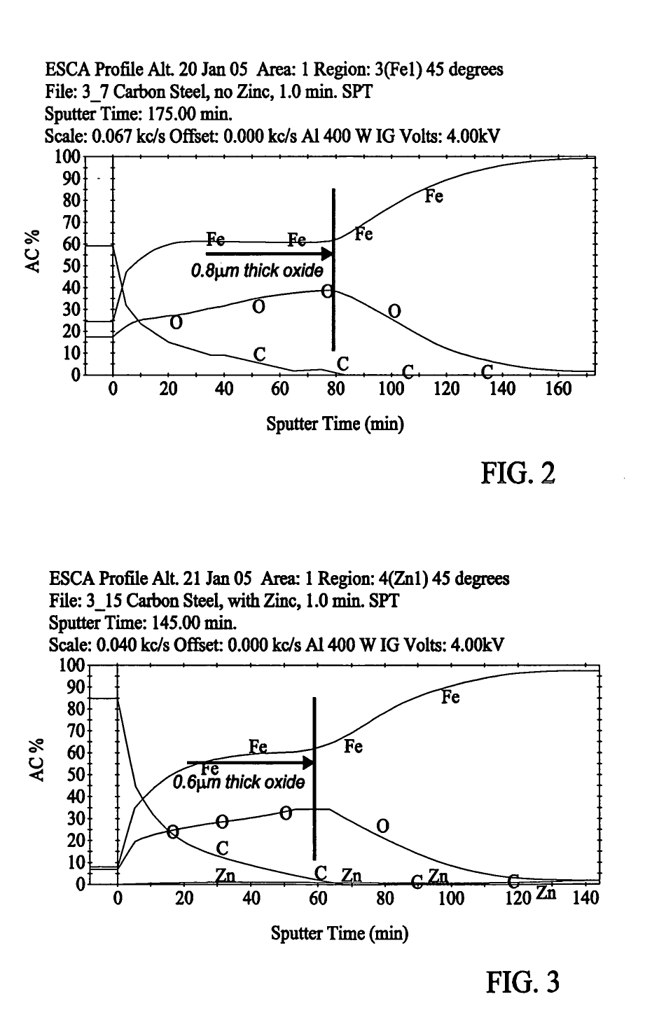

After the two week corrosion testing period, the thickness of the oxide layer on each specimen was measured with a x-ray proton spectroscope (XPS). FIGS. 2 and 3 show the elemental distribution of the oxide layer formed on carbon steel after immersion for two weeks in the high temperature water for the control group specimens and the test group specimens, respectively. FIG. 2 illustrates that the control group specimens have an oxide layer with an average thickness of 0.8 μm after a sputter time of about 80 minutes. In comparison, FIG. 3 illustrates that the test group specimens have an oxide layer with an average thickness of 0.6 μm after a sputter time of about 60 minutes. A comparison of the elemental distribution illustrated in FIG. 3 with the elemental distribution illustrated in FIG. 2 clearly shows that the addition of zinc to the high temperature water results in a decrease in oxide layer thickness, which indicates a decrease in carbon steel corrosion.

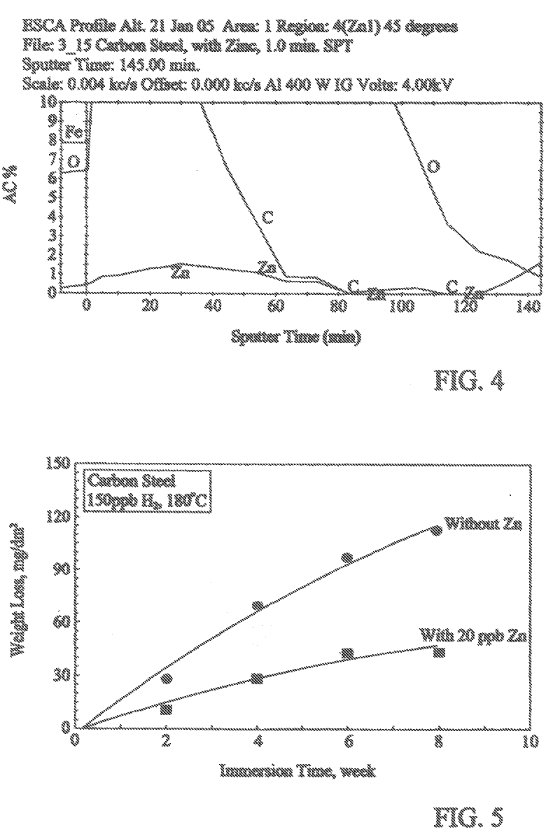

FIG. 4 illustrates a XPS elemental profile of the oxide layer formed on the test group specimens after immersion in the high temperature water for the two week corrosion testing period. The high temperature water had a temperature of 180° C. and contained 150 ppb H₂ and 20 ppb Zn. The XPS elemental profile indicates that in the test group specimens, the oxide layer formed after immersion in the high temperature water for two weeks was enriched with Zn.

FIG. 5 illustrates the weight loss of carbon steel measured in each of the control group specimens and the test group specimens. Each data point indicated on the graph is an average value of weight loss of five specimens. As shown in FIG. 5, the average weight loss of carbon steel, in mg/dm², over an eight week time period is greater for the control group specimens when compared to the test group specimens. Further, the average weight loss of carbon steel increases at a greater rate over the eight week testing period for the control group specimens when compared to the test group specimens. As shown in FIG. 5, after eight weeks, an average weight loss for the control group specimens is about 115 mg/dm², as compared to an average weight loss of about 47.5 mg/dm² for the test group specimens enriched with zinc. The weight loss of carbon steel was significantly reduced by the zinc enrichment. In contrast with the carbon steel specimens including an oxide layer enriched with Zn, the control group specimens without zinc enrichment suffered relatively high carbon steel weight loss from corrosion due to the higher solubility of the oxide film formed on the control group specimens in the high temperature water.

The above-described method for reducing the corrosion of carbon steel components in high temperature, high pressure water facilitates extending a service life of carbon steel components of a nuclear reactor. More specifically, the method facilitates a decrease in oxide layer thickness by enriching the oxide layer with zinc. As a result, the corrosion of carbon steel components in high temperature, high pressure water is reduced, thereby increasing the service life of these carbon steel components.

Exemplary embodiments of a method for reducing the corrosion of carbon steel components in high temperature, high pressure water are described above in detail. The method is not limited to the specific embodiments described herein, but rather, steps of the method may be utilized independently and separately from other steps described herein. Further, the described method steps can also be defined in, or used in combination with, other methods, and are not limited to practice with only the method as described herein.

While the invention has been described in terms of various specific embodiments, those skilled in the art will recognize that the invention can be practiced with modification within the spirit and scope of the claims.

1. (canceled)

2. A method in accordance with claim 5 wherein the compound is added to the feedwater in an amount sufficient to produce a zinc concentration not greater than about 200 ppb.

3. A method in accordance with claim 5 wherein the compound is added to the feedwater in an amount sufficient to produce a zinc concentration of about 50 ppb to about 150 ppb.

4. A method in accordance with claim 1 wherein the compound comprises at least one of depleted ZnO, commercial ZnO, Zn compounds, ZnCl₂, Zn(NO₃)₂, Zn acetate, ZnBr₂, ZnSO₄, fumed Zn compounds, nanoparticles of pure Zn and nanoparticles of Zn compounds.

5. A method for reducing a flow assisted corrosion of at least one of carbon steel components and low alloy steel components in a nuclear reactor having an oxide film layer formed on a surface thereof, said method comprising:
injecting a solution of a compound containing zinc into a supply of feedwater introduced into the nuclear reactor, wherein introducing a solution of a compound containing zinc into a supply of feedwater further comprises injecting a plurality of zinc nanoparticles into the feedwater;
decomposing the compound under operating reactor thermal conditions to release zinc material comprising a plurality of ions of zinc, a plurality of atoms of zinc, or combinations thereof;
introducing the zinc material into the oxide film layer, the zinc material increasing a flow assisted corrosion resistance of at least one of carbon steel and low alloy steel when incorporated into the oxide film layer.

6. A method in accordance with claim 5 wherein introducing a plurality of zinc nanoparticles into the feedwater further comprises injecting zinc nanoparticles having a diameter less than about 100 nanometers.

7. A method in accordance with claim 5 further comprising distributing the nanoparticles on the oxide film layer in response to an interaction with electrostatic forces of the feedwater.

8. A method in accordance with claim 5 further comprising maintaining a temperature of the feedwater at about 100° C. to about 350° C.

9. A method in accordance with claim 5 further comprising maintaining the feedwater in a reducing condition comprising at least one of a low-oxygen, hydrazine and hydrogen water chemistry having an oxygen concentration of less than about 15 ppb.

10. A method in accordance with claim 9 further comprising maintaining the feedwater in a reducing condition within the nuclear reactor comprising one of a boiling water nuclear reactor, a pressurized water nuclear reactor, a VVER nuclear reactor, a pressurized heavy water reactor and a Canada Deuterium Uranium nuclear reactor.

11. A method for reducing a flow assisted corrosion of at least one of carbon steel components and low alloy steel components in a nuclear reactor having an oxide film layer formed on a surface thereof, said method comprising:
injecting a solution of a compound containing zinc into a supply of feedwater introduced into the nuclear reactor;
decomposing the compound under operating reactor thermal conditions to release zinc material comprising a plurality of ions of zinc, a plurality of atoms of zinc, or combinations thereof;
introducing the zinc material into the oxide film layer, the zinc material increasing a flow assisted corrosion resistance of at least one of carbon steel and low alloy steel when incorporated into the oxide film layer,
wherein, upon undergoing decomposition under operating reactor thermal conditions, zinc material is released at a rate such that the concentration of zinc in the water is sufficient, once incorporated into the oxide film layer, to enhance a flow assisted corrosion resistance of the carbon steel components.

12. A method in accordance with claim 11 wherein incorporating the zinc into the oxide film layer further comprises increasing a resistance of the oxide film layer to rupture.

13. A method in accordance with claim 11 wherein incorporating the zinc into the oxide film layer further comprises increasing a strain rate of the oxide film layer.

14. A method for improving a flow assisted corrosion resistance of a carbon steel component including a surface having an oxide film thereon, said method comprising:
immersing the carbon steel surface in high temperature water in which a compound containing zinc nanoparticles is dissolved;
decomposing the compound in the high temperature water to release at least one of ions of zinc and atoms of zinc; and
incorporating the at least one of ions of zinc and atoms of zinc into the oxide film such that the at least one of ions of zinc and atoms of zinc increase the flow assisted corrosion resistance of the carbon steel.

15. A method in accordance with claim 14 wherein decomposing the compound in the high temperature water further comprises producing a zinc concentration not greater than about 200 ppb.

16. A method in accordance with claim 14 wherein decomposing the compound in the high temperature water further comprises producing a zinc concentration of about 0.1 ppt to about 200 ppb.

17. A method in accordance with claim 14 wherein immersing the carbon steel component further comprises immersing the carbon steel component in high temperature water including at least one of depleted ZnO, commercial ZnO, Zn compounds, ZnCl₂, Zn(NO₃)₂, Zn acetate, ZnBr₂, ZnSO₄, fumed Zn compounds, nanoparticles of pure Zn and nanoparticles of Zn compounds.

18. A method in accordance with claim 14 further comprising maintaining the feedwater in a reducing condition comprising at least one of a low-oxygen, hydrazine and hydrogen water chemistry having an oxygen concentration of less than about 15 ppb.

19. A method in accordance with claim 18 further comprising maintaining the feedwater in a reducing condition within the nuclear reactor comprising one of a boiling water nuclear reactor, a pressurized water nuclear reactor, a VVER nuclear reactor, a pressurized heavy water reactor and a Canada Deuterium Uranium nuclear reactor.

20. (canceled)
